(19) United States
(12) Patent Application Publication
(10) Pub. No.: US 2023/0271345 A1
(43) Pub. Date: Aug. 31, 2023

(54) HANDHELD BATTERY POWERED CHAINSAW

(71) Applicant: MILWAUKEE ELECTRIC TOOL CORPORATION, Brookfield, WI (US)

(72) Inventors: Jeremy R. Ebner, East Troy, WI (US); Robert L. Markus, Brookfield, WI (US); Kegan Markwardt, West Allis, WI (US); Michael T. Newby, Brookfield, WI (US); Robert J. Wong, Brookfield, WI (US)

(21) Appl. No.: 18/141,930

(22) Filed: May 1, 2023

Related U.S. Application Data
(63) Continuation-in-part of application No. 17/377,102, filed on Jul. 15, 2021.
Application No. 17/377,102 is a continuation of application No. 15/440,830, filed on Feb. 23, 2017, now abandoned.
Application No. 15/440,830 is a continuation-in-part of application No. 18/093,989, filed on Jan. 6, 2023.
(60) Provisional application No. 62/298,687, filed on Feb. 23, 2016.
(60) Provisional application No. 63/296,907, filed on Jan. 6, 2022.

(51) Int. Cl. B27B 17/00; B27B 17/12; B27B 17/02; B27B 17/08

(52) U.S. Cl. CPC B27B 17/0008; B27B 17/12; B27B 17/02; B27B 17/086

(57) ABSTRACT

A chainsaw includes a housing including a handle housing portion, a motor housing portion, and a drive housing portion. The handle housing portion has a cavity extending along a longitudinal axis defining a first axis. A motor includes an output shaft having a longitudinal axis that defines a second axis. The chainsaw also includes a driven gear coupled to the output shaft, a sprocket coupled to the driven gear such that rotation of the driven gear rotates the sprocket, and a guide bar extending from the drive housing portion and having a longitudinal axis that defines a third axis of the chainsaw. The first and second axes define an included angle less than 75 degrees, the second and third axes define a second included angle between 110 degrees and 130 degrees, and the first and third axes define an external angle between 150 degrees and 170 degrees.

### CROSS-REFERENCE TO RELATED APPLICATIONS

This application is a continuation-in-part of U.S. patent application Ser. No. 17/377,102, filed Jul. 15, 2021, which is a continuation of U.S. patent application Ser. No. 15/440,830, filed Feb. 23, 2017, which claims priority to U.S. Provisional Patent Application No. 62/298,687 filed Feb. 23, 2016, the entire content of each of which is incorporated herein by reference. This application is also a continuation-in-part of U.S. patent application Ser. No. 18/093,989, filed Jan. 6, 2023, which claims priority to U.S. Provisional Patent Application No. 63/296,907, filed Jan. 6, 2022, the entire content of each of which is incorporated herein by reference.

### BACKGROUND

The present disclosure relates to chainsaws, and more particularly to portable, battery-powered chainsaws.

Chainsaws are typically large and heavy, requiring two-handed operation. Prolonged use of such chainsaws may lead to operator fatigue. In addition, the weight and size of such chainsaws may render them impractical for use in overhead, confined, or other difficult cutting positions.

### SUMMARY

The disclosure provides, in one aspect, a chainsaw including a housing having a handle housing portion, a motor housing portion, and a drive housing portion. The handle housing portion has a longitudinal axis that defines a first axis of the chainsaw. The chainsaw also includes a motor supported by the motor housing portion and having an output shaft with a longitudinal axis that defines a second axis of the chainsaw. The chainsaw further includes a driven gear coupled to the output shaft such that the driven gear rotates in response to rotation of the output shaft, a sprocket coupled to the driven gear such that rotation of the driven gear rotates the sprocket, and a guide bar extending from the drive housing portion and having a longitudinal axis that defines a third axis of the chainsaw. A chain is supported on the guide bar and engaged with the sprocket such that rotation of the sprocket moves the chain along the guide bar. The first axis, the second axis, and the third axis are generally coplanar, and the first axis and the second axis define a first included angle between about 75 degrees and about 95 degrees.

The disclosure provides, in another aspect, a chainsaw including a housing having a handle housing portion, a motor housing portion, and a drive housing portion. The handle housing portion has a longitudinal axis that defines a first axis of the chainsaw. The chainsaw also includes a motor supported by the motor housing portion. The motor includes an output shaft having a longitudinal axis that defines a second axis of the chainsaw. A guide bar extends from the drive housing portion and has a longitudinal axis that defines a third axis of the chainsaw. The chainsaw further includes a chain supported on the guide bar. The first axis and the second axis define a first included angle between about 75 degrees and about 95 degrees, the second axis and the third axis define a second included angle between about 110 degrees and about 130 degrees, and the first axis and the third axis define an external angle between about 150 degrees and about 170 degrees.

The disclosure provides, in another aspect, a chainsaw including a housing having a handle housing portion with a cavity and a longitudinal axis that defines a first axis of the chainsaw. The chainsaw also includes a motor supported within the housing and having an output shaft with a longitudinal axis that defines a second axis of the chainsaw. The chainsaw further includes a battery configured to provide power to the motor, the battery being received in the cavity along the first axis. A guide bar extends from the housing and has a longitudinal axis that defines a third axis of the chainsaw. The chainsaw further includes a chain supported on the guide bar, and the chain includes a plurality of cutting elements. The first axis, the second axis, and the third axis are generally coplanar, and the first axis, the second axis, and the third axis are oblique with respect to each of the other axes.

The disclosure provides, in another aspect, a chainsaw configured to be powered by a battery pack. The chainsaw includes a housing, a guide bar, and a power and drive assembly. The housing includes a battery interface for receiving the battery pack. The guide bar guides a cutting chain and is removably coupled to the housing. The power and drive assembly includes a motor and a gear train. The motor is disposed within the housing and is configured to be powered by the battery pack. The gear train is driven by the motor and configured to drive the cutting chain. The housing, the guide bar, and the power and drive assembly each contribute to a total weight of the chainsaw. A power output by the power and drive assembly compared to the total weight defines a power-to-weight ratio of above 150 Watts per Pound.

The disclosure provides, in another aspect, a chainsaw configured to be powered by a battery pack. The chainsaw includes a housing, a guide bar, and a power and drive assembly. The housing includes a battery interface for receiving the battery pack and defines a receptacle. The guide bar guides the cutting chain and is removably coupled to the housing. When coupled to the housing, the guide bar is at least partially received in the receptacle. The guide bar has a length extending between a distal end of the guide bar and the receptacle. The power and drive assembly is configured to drive the cutting chain about the guide bar. A power output of the power and drive assembly compared to the length of the guide bar defines a power-to-length ratio of above 140 Watts per inch.

The disclosure provides, in another aspect, a chainsaw configured to be powered by a battery pack. The chainsaw includes a housing, a guide bar, and a power and drive assembly. The housing includes a battery interface, the housing having a length. The guide bar guides a cutting chain and is removably coupled to the housing. The power and drive assembly is configured to drive the cutting chain about the guide bar. A power output of the power and drive assembly compared to the length of the housing defines a power-to-length ratio of above 75 Watts per inch.

Other features and aspects of the disclosure will become apparent by consideration of the following detailed description and accompanying drawings.

### BRIEF DESCRIPTION OF THE DRAWINGS

FIG. 1 is a side view of a portable hand tool according to one embodiment.

FIG. 2 is another side view of the portable hand tool of FIG. 1.

FIG. 3 is a cross-sectional view of the portable hand tool of FIG. 1.

FIG. 4 is a front perspective view of a chainsaw according to an embodiment.

FIG. 5 is another front perspective view of the chainsaw of FIG. 4 with a housing of the chainsaw removed.

FIG. 6 is a perspective view of a power and drive assembly of the chainsaw of FIG. 4.

FIG. 7 is a schematic view of an automatic oiling system of the chainsaw of FIG. 4.

FIG. 8 is an exploded view of the chainsaw of FIG. 4 with some components of the housing hidden to illustrate components of the automatic oiling system of FIG. 7.

Before any embodiments of the disclosure are explained in detail, it is to be understood that the disclosure is not limited in its application to the details of embodiment and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

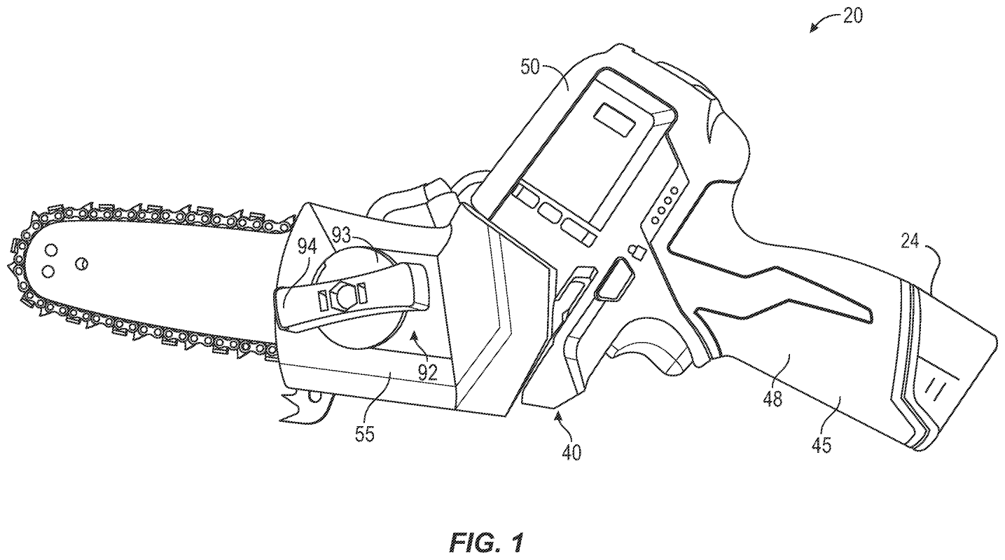

FIGS. 1-3 illustrate a portable hand tool 20 or a portable chainsaw according to one embodiment. The chainsaw 20 is powered by a rechargeable power tool battery pack 24 (FIG. 1). For example, the illustrated battery pack 24 is an interchangeable battery pack configured to connect to and power a variety of tools in addition to the chainsaw 20. In some embodiments, the battery pack 24 is a 12-volt lithium-ion battery pack including three battery cells (not shown) connected in series. In other embodiments, the battery pack 24 may include fewer or more battery cells, and the battery pack 24 may have other nominal output voltages, such as 14.4 volts, 18 volts, etc. Additionally or alternatively, the battery cells may have chemistries other than lithium-ion such as, for example, nickel cadmium, nickel metal-hydride, or the like. In still other embodiments, the chainsaw 20 may be a corded power tool.

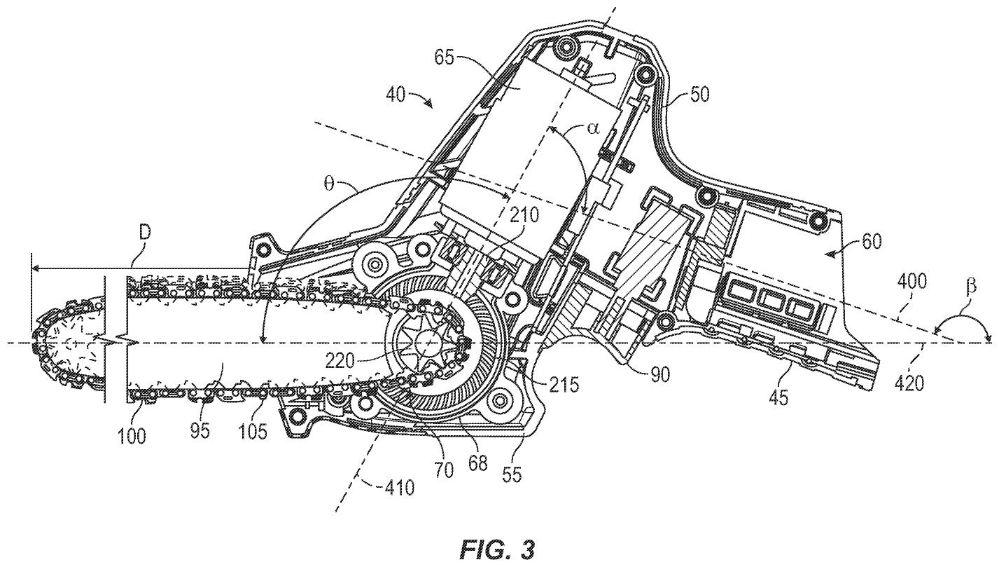

With continued reference to FIG. 1, the chainsaw 20 includes a housing 40. The housing 40 defines a handle housing portion 45, a motor housing portion 50 and a drive housing portion 55. The handle housing portion 45 includes at least one grip surface 48 for a user to grasp while operating the chainsaw 20. In the illustrated embodiment, the handle housing portion 45 includes a battery receiving portion 60 (FIG. 3) for receiving at least a portion of the battery pack 24. In other embodiments, the battery receiving portion 60 may be defined elsewhere on or within the housing 40. An electric motor 65, which may be, for example, a brushed or brushless DC motor, is supported within the motor housing portion 50. A drive mechanism 70, located in the drive housing portion 55, is mechanically coupled to the electric motor 65.

Referring to FIGS. 1 and 3, the illustrated battery receiving portion 60 is configured as a cavity. When the battery pack 24 is connected to the chainsaw 20, the pack 24 is inserted into the cavity 60 and substantially fills the cavity 60. In other embodiments, the battery pack 24 may couple with the battery receiving portion 60 in other ways, such as with an external rail structure. A terminal block is positioned in the cavity 60 to electrically connect the battery pack 24 to the motor 65. A switch 90 is positioned on the handle housing portion 45 for operating the chainsaw 20. As illustrated, the switch 90 is an on/off trigger switch. In other embodiments, the switch 90 may be a variable speed trigger switch, a two speed trigger switch, a push button, or any other suitable actuator. A knob 92 is positioned on a lateral side (i.e. a left side in the illustrated embodiment) of the drive housing portion 55 (FIG. 1). The knob 92 includes a rounded portion 93 adjacent the drive housing portion 55 and a graspable wing portion 94 extending from the rounded portion 93.

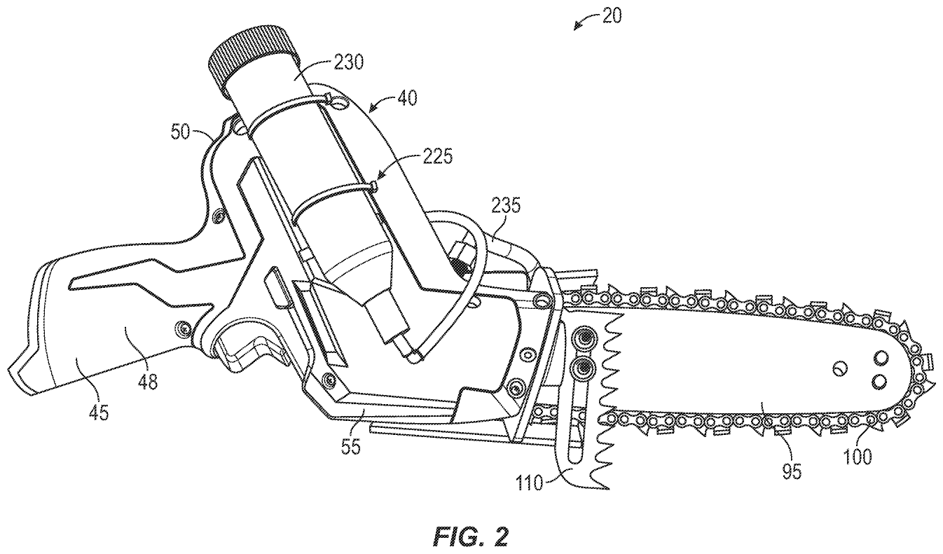

With continued reference to FIG. 3, the chainsaw 20 further includes a guide bar 95 extending from the drive housing portion 55. The guide bar 95 supports a saw chain 100 having a plurality of cutting elements 105. The cutting elements 105 may have any desired configuration, such as full chisel, semi-chisel, chipper, or the like. Referring to FIG. 2, an adjustable bumper spike 110 is coupled to the drive housing portion 55. The bumper spike 110 may be used to engage a workpiece and provide a pivot point during a cutting operation. In other embodiments, the bumper spike 110 may be omitted.

The drive mechanism 70 includes a driving gear 210 and a driven gear 215 (FIG. 3). In the illustrated embodiment, the driving gear 210 is a spiral bevel pinion and the driven gear 215 is a spiral bevel gear. The driven gear 215 is oriented with its teeth facing the left side of the drive housing portion 55. In other embodiments, the driving gear 210 and driven gear 215 may have other configurations. In addition, one or more reduction gears may be provided between the driving gear 210 and the driven gear 215. A sprocket 220 is coupled to the driven gear 215 for rotation therewith. The saw chain 100 wraps around the sprocket 220 such that rotation of the sprocket 220 advances the saw chain 100 along the guide bar 95. In some embodiments, the sprocket 220 may be integrally formed with the driven gear 215. In other embodiments, the sprocket 220 may be provided as part of the guide bar 95.

With reference to FIG. 2, the chainsaw 20 further includes a lubrication system 225 for supplying lubrication (e.g., bar and chain oil) to the drive mechanism 70, the saw chain 100, and/or the guide bar 95. The lubrication system 225 includes a lubricant reservoir 230 and a conduit 235 extending from the reservoir 230 into the drive housing portion 55 of the housing 40. In the illustrated embodiment, the lubricant reservoir 230 is located on the exterior of the housing 40. In other embodiments, the lubricant reservoir 230 may be located fully or partially within the housing 40. In other embodiments, the chainsaw 20 may not include a lubrication system.

Referring to FIG. 3, in some embodiments, the guide bar 95 defines an overall length between about 6 inches and about 16 inches. In other embodiments, the guide bar 95 defines an overall length between about 8 inches and about 14 inches. In the illustrated embodiment, the overall length of the bar 95 is about 11 inches. The guide bar 95 projects from the forward-most edge of the drive housing portion 55 by a distance D. In some embodiments, the distance D is between about 3 inches and about 12 inches. In other embodiments, the distance D is between about 4 inches and about 10 inches. In other embodiments, the distance D is between about 4 inches and about 8 inches. In the illustrated embodiment, the distance D is about 6 inches. Accordingly, in the illustrated embodiment, a ratio of the distance D to the overall length of the guide bar 95 is about 0.5.

With continued reference to FIG. 3, the battery pack 24 is insertable into the battery cavity 60 of the chainsaw 20 along a handle axis 400, which also defines a battery insertion axis. The motor 65 defines a longitudinal motor axis 410 along a length of the motor 65. The guide bar 95 is positioned along a longitudinal or cutting axis 420 defined along the length of the guide bar 95. In the illustrated embodiment, the axes 400, 410, 420 are positioned such that each axis 400, 410, 420 is coplanar. In addition, the axes 400, 410, 420 are oblique, or not otherwise perpendicular and/or parallel with respect to the other axes. More specifically, the handle axis 400 is positioned at an angle α with respect to the motor axis 410, the motor axis 410 is positioned at an angle θ with respect to the longitudinal axis 420, and the longitudinal axis 420 is positioned at an angle β with respect to the handle axis 400. In some embodiments, each of the axes 400, 410, 420 may be either non-parallel or non-orthogonal with respect to each of the other axes 400, 410, 420.

In the illustrated embodiment, each of the axes 400, 410, 420 is oblique with respect to the other axes 400, 410, 420. Angle α is an angle defined between the handle axis 400 and the motor axis 410 and is in a range of about 75 degrees to about 95 degrees. In the illustrated embodiment, angle α is about 85 degrees. In still other embodiments, angle α may be greater than 95 degrees or less than 75 degrees. Angle θ is an angle defined between the motor axis 410 and the longitudinal axis 420 and is an obtuse angle in some embodiments. For example, the angle θ may be in a range between about 110 degrees and about 130 degrees. In the illustrated embodiment, angle θ is about 120 degrees. In other embodiments, angle θ may be greater than 130 degrees or less than 110 degrees. Angle β is an angle defined between the handle axis 400 and the longitudinal axis 420 and is in a range of about 150 degrees to about 170 degrees. In the illustrated embodiment, angle β is about 161.7 degrees. In other embodiments, angle β is greater than 170 degrees or less than 150 degrees.

The position of the axes, the size of the chainsaw 20, the length of the guide bar 95, and other characteristics are designed for optimal cutting, portability, and ergonomics. For example, the orientation of motor 65 and the position of the motor 65 generally above the guide bar 95 (with reference to the orientation of FIG. 2) allows the chainsaw 20 to be more compact by reducing the overall length of chainsaw 20 as compared to the length of a conventional chainsaw. The handle axis 400 is oriented for optimal user operation with regard to handle grip location and angle for performing a cutting operation. Finally, the chainsaw 20 is relatively lightweight, weighing between about 3 pounds and about 7 pounds (excluding the battery pack) in some embodiments. In the illustrated embodiment, the chainsaw 20 weighs between about 4 pounds and about 5 pounds. The foregoing features and characteristics facilitate one-handed operation of the chainsaw 20, as well as use of the chainsaw 20 in a variety of different operating positions.

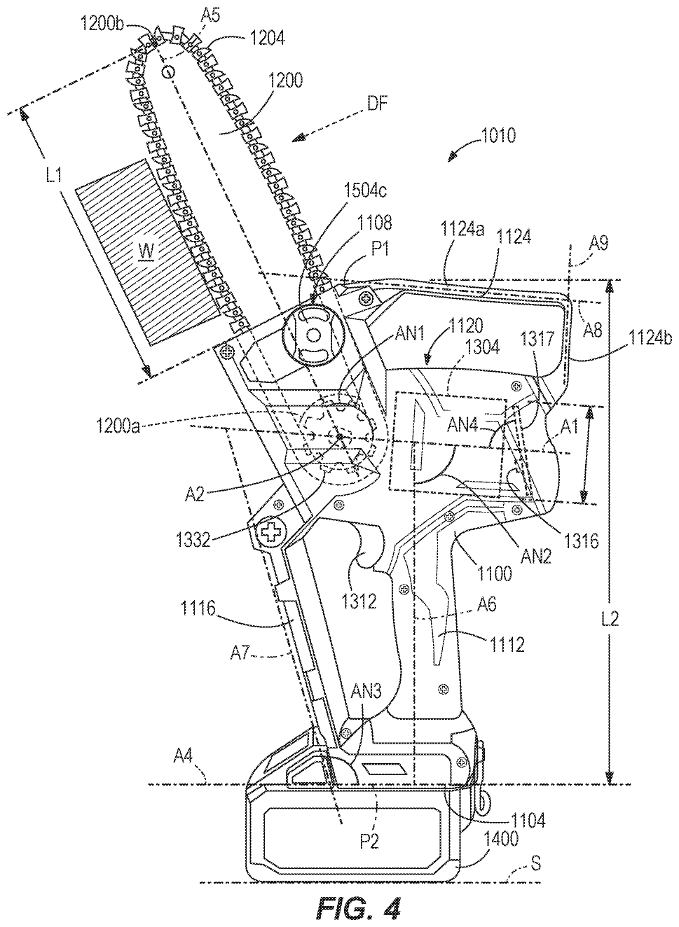

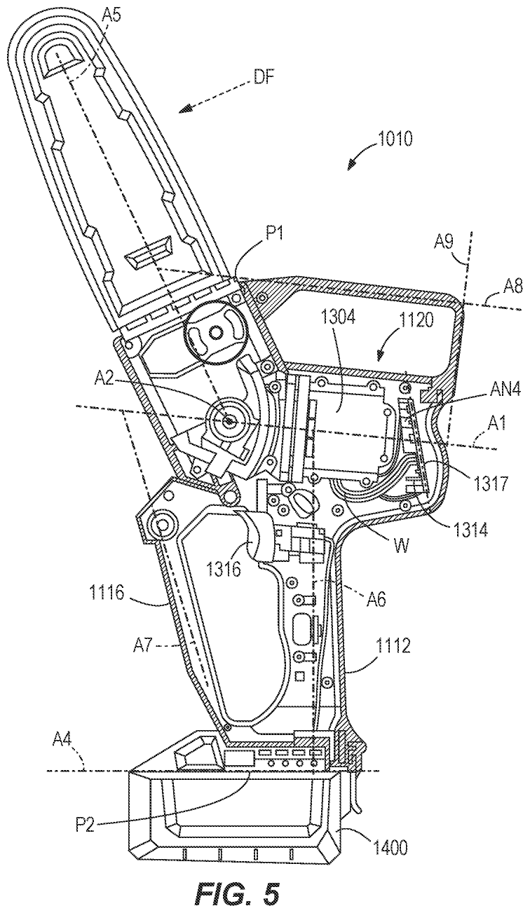

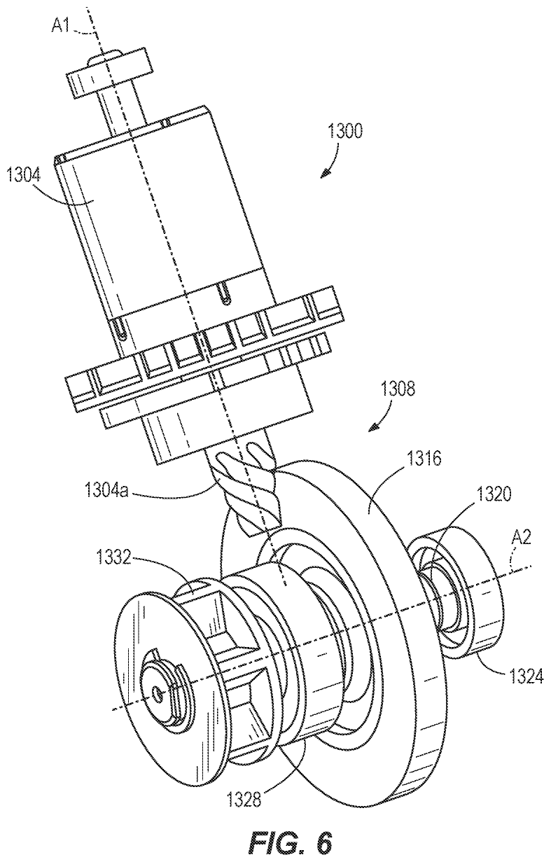

FIGS. 4 and 5 illustrate a power tool, such as a portable chainsaw 1010. The chainsaw 1010 includes a housing 1100 and a guide bar 1200 selectively coupled to the housing 1100. The guide bar 1200 supports a chain 1204 (e.g., a cutting chain) that is driven around the guide bar 1200 by a power and drive assembly 1300 to make a cut in a workpiece W. The power and drive assembly 1300 includes a motor 1304 and a gear train 1308 (FIG. 6) supported within the housing 1100. The power and drive assembly 1300 further includes a trigger 1312 coupled with control electronics 1314. The motor 1304 is coupled to the control electronics 1314, the control electronics 1314 being capable of controlling operation of the motor 1304. The control electronics 1314 are configured to receive electrical input power from the battery pack 1400 and operate the motor 1304 to provide output mechanical power to drive the chain 1204 around the guide bar 1200. The portable chainsaw 1010 is coupled to a battery pack 1400 at a battery interface 1104 of the housing 1100. The portable chainsaw 1010 is configured to be powered by the battery pack 1400. The battery interface 1104 electrically couples the battery pack 1400 to the control electronics 1314. Upon depressing the trigger 1312, the control electronics 1314 activate operation of the motor 1304 to ultimately drive the chain 1204 around the guide bar 1200. To stop operation of the motor 1304, the trigger 1312 is released, and the chain 1204 comes to rest upon the guide bar 1200. As will be discussed in detail below, the portable chainsaw 1010 further includes an automatic oiling assembly 1500 coupled to the power and drive assembly 1300 to provide oil from an on-board oil tank 1504 to at least one of the guide bar 1200 and the chain 1204 during operation of the portable chainsaw 1010.

FIG. 6 illustrates the power and drive assembly 1300 in detail. The motor 1304 is coupled to an output gear 1304a. In the illustrated embodiment, the output gear 1304a is a spiral bevel gear. The output gear 1304a rotates about a motor axis A1. The output gear 1304a of the motor 1304 is coupled to a spiral bevel gear 1316. The spiral bevel gear 1316 is coupled to an output shaft 1320. The spiral bevel gear 1316 and the output shaft 1320 rotate about a sprocket axis A2. In the illustrated embodiment, the sprocket axis A2 is generally perpendicular to the motor axis A1. The output shaft 1320 is supported within the housing 1100 by bearings 1324, 1328. The spiral bevel gear 1316 is positioned between the bearings 1324, 1328. The output shaft 1320 is further coupled to a chain sprocket 1332. As best illustrated in FIG. 4, the chain 1204 is coupled to the chain sprocket 1332 for co-rotation therewith. In other words, the chain sprocket 1332, a component of the gear train 1308, is coupled to the chain 1204, which is supported by the guide bar 1200. Accordingly, while the motor 1304 is operated, the output gear 1304a rotates about the motor axis A1, and the spiral bevel gear 1316, the output shaft 1320, and the chain sprocket 1332 rotate about the sprocket axis A2.

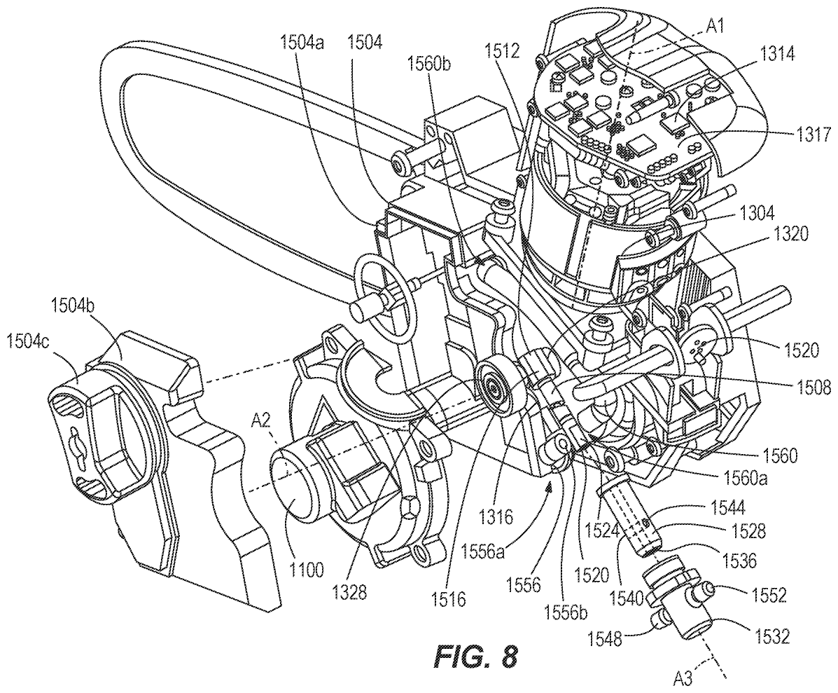

FIG. 8 illustrates the automatic oiling assembly 1500 in detail. The oil tank 1504 includes a housing portion 1504a and a cap portion 1504b. FIG. 8 illustrates the cap portion 1504b removed from the housing portion 1504a. The cap portion 1504b is coupled to an adjustable (e.g., rotatable) knob 1504c configured to adjust venting of external air into the oil tank 1504. The automatic oiling assembly 1500 includes an oiler shaft 1508. The oiler shaft 1508 has a first end 1512 having spur teeth 1516 and an opposite second end 1520 having a key 1524. The key 1524 is dimensioned as a radially inwardly extending depression in the second end 1520 of the oiler shaft 1508. The spur teeth 1516 engage the output shaft 1320. Accordingly, as the output shaft 1320 is rotated, the oiler shaft 1508 rotated about an oiler axis A3.

The automatic oiling assembly 1500 further includes a pump cylinder 1528 and a pump housing 1532. FIG. 8 illustrates the pump cylinder 1528 and the pump housing 1532 exploded from the oiler shaft 1508. The pump cylinder 1528 includes a passageway 1536 within which the second end 1520 of the oiler shaft 1508 is received. The passageway 1536 is in fluid communication with an inlet opening 1540 and an outlet opening 1544 each formed in the pump cylinder 1528. The inlet opening 1540 and the outlet opening 1544 are on opposite radial sides of the passageway 1536. In the assembly of the portable chainsaw 1010, the pump cylinder 1528 is located within the pump housing 1532. The pump housing 1532 includes a pump inlet 1548 and a pump outlet 1552. The pump inlet 1548 is radially positioned adjacent the inlet opening 1540, and the pump outlet 1552 is radially positioned adjacent the outlet opening 1544.

The automatic oiling assembly 1500 further includes a pump inlet tube 1556 with a first end 1556a coupled to the oil tank 1504 and an opposite second end 1556b coupled to the pump inlet 1548. The automatic oiling assembly 1500 further includes a pump outlet tube 1560 with a first end 1560a coupled to the pump outlet 1552 and a second end 1560b terminating adjacent the guide bar 1200 and the chain 1204.

Accordingly, during operation of the portable chainsaw 1010, the output shaft 1320 rotates the oiler shaft 1508. When the key 1524 is aligned with the inlet opening 1540, oil from the oil tank 1504 is passed through the pump inlet tube 1556 through the pump inlet 1548 and the inlet opening 1540 and to a location between the key 1524 and the passageway 1536. The output shaft 1320 continues to rotate until the key 1524 is aligned with the outlet opening 1544. At this time, oil from between the key 1524 and the passageway 1536 is passed through the outlet opening 1544 and the pump outlet 1552 and through the pump outlet tube 1560 to a position adjacent the guide bar 1200 and the chain 1204. Accordingly, the automatic oiling assembly 1500 is driven by the gear train 1308, the automatic oiling assembly 1500 being configured to receive mechanical input from the gear train 1308 and transmit oil from the oil tank 1504 to at least one of the guide bar 1200 and the chain receives oil from the oil tank 1504. During operation of the automatic oiling assembly 1500, the oiler shaft 1508 including the key 1524, in conjunction with the passageway 1536 of the pump cylinder 1528 function as a pump (e.g., an axial piston pump) to transmit oil from the oil tank 1504 to at least one of the guide bar 1200 and the chain 1204. Other such pump mechanisms may be similarly driven by the output shaft 1320. For example, the oiler shaft 1508 may be configured to power other types of pumps, such as, and without limitation, an external gear pump, an internal gear pump, a gerotor pump, a peristaltic pump, or a lobe pump.

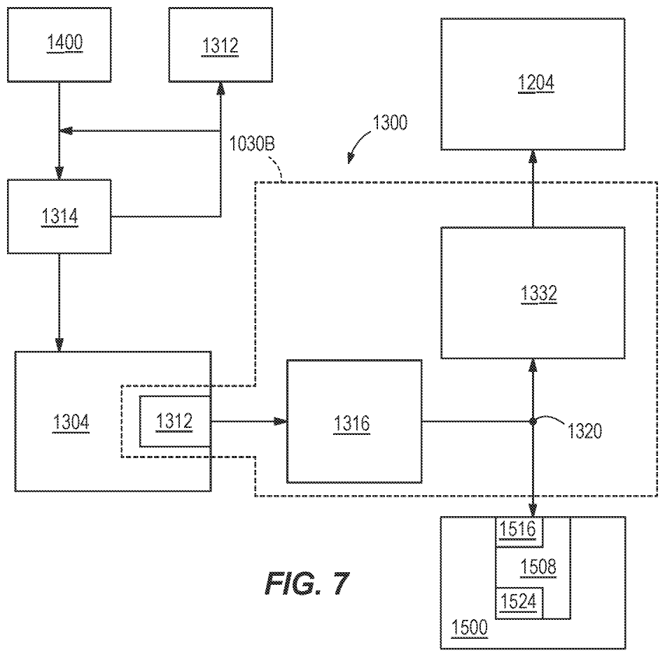

FIG. 7 schematically illustrates the operation of the portable chainsaw 1010 through the power and drive assembly 1300. The control electronics 1314 receive power from the battery pack 1400 and receive a signal to operate the motor 1304 from the trigger 1312 upon depression of the trigger 1312. In some embodiments, the trigger 1312 is also powered by the battery pack 1400 through the control electronics 1314. When the trigger 1312 is depressed, the motor 1304 is operated. The gear train 1308 provides rotation to the output shaft 1320 which powers rotation of the oiler shaft 1508 of the automatic oiling assembly 1500. The gear train 1308 also provides rotation to the output shaft 1320 which connects to the chain sprocket 1332 and rotates the chain 1204.

Returning to FIG. 4, various aspects of the portable chainsaw 1010 relate to the configuration of the housing 1100. As previously mentioned, the housing 1100 includes the battery interface 1104. The battery interface 1104 is configured to receive the battery pack 1400 upon translation of the battery pack along a battery axis A4. Once coupled to the battery interface 1104, the battery pack 1400 can rest on a surface S with the portable chainsaw 1010 being supported (e.g., balanced) by the battery pack 1400.

The housing 1100 further includes a guide bar receptacle 1108 within which at least a portion of the guide bar 1200 is received. In the illustrated embodiment, the guide bar receptacle 1108 is positioned generally on the opposite end of the housing 1100 as the battery interface 1104. With continued reference to FIG. 4, the guide bar 1200 includes a proximal end 1200a and an opposite distal end 1200b. The proximal end 1200a is located adjacent the sprocket 1332 within the guide bar receptacle 1108. The distal end 1200b projects from the guide bar receptacle 1108 such that at least a portion of the chain 1204 can make a cut in a workpiece W. The guide bar 1200 extends along a guide bar axis A5 between the proximal end 1200a and the distal end 1200b. The guide bar 1200 defines a guide bar length L1 extending between the distal end 1200b and the guide bar receptacle 1108. In other words, the guide bar length L1 represents the exposed portion of the guide bar 1200 projecting from the housing 1100. In the illustrated embodiment, the guide bar length L1 is approximately 7.5 inches (19 centimeters). The illustrated guide bar 1200 extends between the proximal end 1200a and the distal end 1200b of approximately 9.5 inches (24 centimeters). The illustrated guide bar 1200 may be advertised, for example, as an 8-inch (20 centimeter) guide bar 1200. Other lengths L1, distances between the proximal end and the distal end 1200a, 1200b, and advertised guide bar size are possible. The guide bar 1200 may be a removable (i.e., selectively couplable) guide bar 1200 which can be removed from the housing 1100 for transport of the chainsaw 1010 or replacement of the guide bar 1200. In some embodiments, the guide bar 1200 may also be movable (i.e., selectively positionable) along the guide bar axis A5 relative to the housing 1100 into and out of the guide bar receptacle 1108 for tensioning the chain 1204.

With continued reference to FIG. 4, the guide bar axis A5 crosses the motor axis A1 at the sprocket axis A2. The guide bar axis A5 also extends away from the motor axis A1 and the motor 1304 at an oblique angle AN1. In the illustrated embodiment, the angle AN1 is approximately 120 degrees. Other angles AN1 are possible.

The housing 1100 further includes a primary handle 1112 extending between the motor 1304 and the battery interface 1104 along a primary handle axis A6. The primary handle axis A6 is generally perpendicular to the battery axis A4. The primary handle axis A6 traverses the motor axis A1 at an angle AN2. The angle AN2 is near perpendicular, but is slightly less than 90 degrees. For example, in the illustrated embodiment, the angle AN2 is approximately 86 degrees. Other angles AN2 are possible.

The housing 1100 further includes a handle guard 1116 coupled to the battery interface 1104 and extending generally toward the guide bar 1200. The trigger 1312 is positioned between the primary handle 1112 and the handle guard 1116. Accordingly, during use of the portable chainsaw 1010, an operator's hand holding the primary handle 1112 and touching the trigger 1312 may be shielded from any cuttings generated by the chain 1204. The handle guard 1116 extends along a guard axis A7. In the illustrated embodiment, the guard axis A7 is angled relative to the battery axis A4 an angle AN3. The angle AN3 in the illustrated embodiment is oblique. The angle AN3 in the illustrated embodiment is an obtuse angle, and is approximately 106 degrees. Other angles AN3 are possible.

The housing 1100 further includes a motor receptacle 1120 within which the motor 1304 is received. The portable chainsaw 1010 further includes a hand guard 1124 coupled to the guide bar receptacle 1108 and the motor receptacle 1120. The hand guard 1124 includes a first portion 1124a and a second portion 1124b. The first portion 1124a extends along a first hand guard axis A8. In some embodiments, the first portion 1124a may have indicia to indicate to a user not to grasp the hand guard 1124. The second portion 1124b extends along a second hand guard axis A9. The first hand guard axis A8 is generally parallel with the motor axis A1. The second hand guard axis A9 is generally perpendicular with the motor axis A1. The hand guard 1124 may inhibit debris or other material from contacting a user.

With continued reference to FIG. 4, the portable chainsaw 1010 is compact. The housing 1100 defines a first point P1 and a second point P2 offset a maximum housing length L2 from one another. The maximum housing length L2 may account for the housing 1100 size without considering different sized and/or positioned battery packs 1400 and/or guide bars 1200. In the illustrated embodiment, the maximum housing length L2 is approximately 12 inches (30 centimeters). Other portable chainsaws 1010 may have differing maximum housing lengths L2. In the illustrated embodiment, the maximum housing length L2 is measured in a plane defined by the guide bar axis A5 and the motor axis A1.

One consideration that allows the portable chainsaw 1010 to be compact is the location of the control electronics 1314. In the illustrated embodiment, at least one component of the control electronics 1314 is mounted upon a printed circuit board 1317. The printed circuit board 1317 is positioned within the motor receptacle 1120 at a position opposite the motor 1304 when compared to the gear train 1308 (the gear train 1308 including the sprocket 1332). The motor axis A1 passes through the printed circuit board 1317. The printed circuit board 1317 is angled relative to the motor axis A1 at an angle AN4. The angle AN4 in the illustrated embodiment is acute and is approximately 76 degrees. Other angles AN4 are possible.

Various components of the portable chainsaw 1010 contribute to high power-output and high efficiency of the chainsaw 1010, leading to high performance of the portable chainsaw 1010. First, the battery pack 1400 is a high-performance battery pack 1400. In the illustrated embodiment, the battery pack 1400 is lithium-based. Other battery packs may be nickel-based, or have differing chemistries. The battery pack 1400 may be a high-output battery pack (e.g., 6.0 Ah), such as the M18™ REDLITHIUM™ HIGH OUTPUT™ XC6.0 battery pack, manufactured and sold by Milwaukee Electric Tool, Milwaukee, Wis. Such a battery pack 1400 weighs approximately 2.3 pounds (1.0 kilograms). The battery pack 1400 may be operable to provide at least 1000 Watts of electrical input power to the power and drive assembly 1300. In some embodiments, the battery pack 1400 has an operating voltage of approximately 18 volts. The battery pack 1400 may have, for example, an output current of 6.0 amps. Other suitable battery packs 1400 may have different operating voltages, output currents, power outputs, and/or different weights.

The battery pack 1400 is also a high-capacity battery pack 1400. When the battery pack 1400 is used to power the portable chainsaw 1010, the battery pack 1400 is configured to make at least 150 cuts of 3.5-inch by 3.5-inch (8.9-centimeter by 8.9-centimeter) (e.g., a piece of dimensional lumber commonly referred to as a “four by four”) pressure-treated lumber on a single charge. For instance, the pressure-treated lumber may be pine. The battery pack 1400 can make at least 160 cuts of 3.5-inch by 3.5-inch (8.9-centimeter by 8.9-centimeter) pressure-treated lumber on a single charge. In some instances, the battery pack 1400 can make 179 cuts of 4-inch by 4-inch (10 centimeter by 10-centimeter) pressure-treated lumber on a single charge. Similarly, when the battery pack 1400 is used to power the portable chainsaw 1010, the battery pack 1400 is configured to make at least 80 cuts of 5.5-inch by 5.5-inch (14-centimeter by 14-centimeter) (e.g., a piece of dimensional lumber commonly referred to as a “six by six”) pressure-treated lumber on a single charge. In fact, the battery pack 1400 can make at least 89 cuts of 5.5-inch by 5.5-inch (14-centimeter by 14-centimeter) pressure-treated lumber on a single charge.

During cutting of the 3.5-inch by 3.5-inch (8.9-centimeter by 8.9-centimeter) and 5.5-inch by 5.5-inch (14-centimeter by 14-centimeter) pressure-treated lumber, a downforce of approximately 30 pounds (13.6 kilograms) was applied to the portable chainsaw 1010 in a direction DF (FIGS. 4, 5). While cutting through a workpiece W of 3.5-inch by 3.5-inch (8.9-centimeter by 8.9-centimeter) pressure-treated lumber and while applying a downforce of 30 pounds (13.6 kilograms) in the direction DF, the chainsaw 1010 cut through the 3.5-inch by 3.5-inch (8.9-centimeter by 8.9-centimeter) pressure-treated lumber in approximately 3.07 seconds. In other words, the 3.5-inch by 3.5-inch (8.9-centimeter by 8.9-centimeter) pressure-treated lumber was cut within 3.5 seconds. Accordingly, the guide bar 1200 was passed at speed of (3.5 inches/3.07 seconds, 8.89 centimeters/3.07 seconds) about 1.14 inches per second (2.89 centimeters per second). While cutting through a workpiece W of 5.5-inch by 5.5-inch (14-centimeter by 14-centimeter) pressure-treated lumber and while applying a downforce of 30 pounds (13.6 kilograms) in the direction DF, the chainsaw 1010 cut through the 5.5-inch by 5.5-inch (14-centimeter by 14-centimeter) pressure-treated lumber in approximately 5.97 seconds. In other words, the 5.5-inch by 5.5-inch (14-centimeter by 14-centimeter) pressure-treated lumber was cut within 6.25 seconds. Accordingly, the guide bar 1200 was passed at speed of (5.5 inches/5.97 seconds, 13.97 centimeters/5.97 seconds) about 0.92 inches per second (2.34 centimeters per second).

The control electronics 1314 and the printed circuit board 1317 must also be constructed of adequate quality (e.g., size, capacity) to provide adequate capacity to transmit the at least 1000 Watts of electrical input power to the motor 1304. For example, wires W (FIG. 6) coupling the battery pack 1400 to the control electronics 1314 and the printed circuit board 1317 must be adequately sized. Further, the control electronics 1314 and the printed circuit board 1317 must be adequately cooled during operation of the portable chainsaw 1010.

Next, the motor 1304 must be a high-power motor 1304. The motor 1304 must operate at torque and speed configured to provide output mechanical power to drive the chain 1204 around the guide bar. In some embodiments, this output mechanical power is at least 1000 Watts. The motor 1304 is operable to output a maximum output power while cutting a workpiece of 3.5-inch by 3.5-inch (8.9-centimeter by 8.9-centimeter) pressure-treated lumber of at least 1100 Watts. In the illustrated embodiment, the motor 1304 can reach instantaneous mechanical output power of approximately 1200 Watts. This instantaneous mechanical output power was observed while the portable chainsaw 1010 cut a 3.5-inch by 3.5-inch (8.9-centimeter by 8.9-centimeter) piece of pressure-treated lumber.

The automatic oiling assembly 1500 may provide adequate amounts of lubrication to at least one of the guide bar 1200 and the chain 1204 to inhibit excess undesired heat production during rotation of the chain 1204 about the guide bar 1200. Such undesired heat production may cause binding of the chain 1204 upon the guide bar 1200, inhibiting a cutting operation of the chainsaw 1010. Oil from the automatic oiling assembly 1500 may absorb at least some of the heat generated between the chain 1204 and the guide bar 1200. The automatic oiling assembly 1500 is sized to provide an adequate volumetric flow rate of lubrication from the oil tank 1504 to at least one of the guide bar 1200 and the chain 1204. Accordingly, large amounts of power (e.g., at least a maximum of 1200 Watts, as further described below) may be applied through the chain 1204 to the workpiece W without overheating of the guide bar 1200 and chain 1204, which may cause binding of the chain 1204 onto the guide bar 1200.

The housing 1100 and the fastening of each of the components of the portable chainsaw 1010 thereto are capable of withstanding forces generated while applying high amounts of power to the workpiece W. For example, the fastening mechanism between the guide bar 1200 and the housing 1100 is rigid enough to withstand both the forces generated by the chain 1204 as well as the downforce in direction DF. Similarly, the bearings 1324, 1328 which support the output shaft 1320 within thin the housing 1100 can withstand the forces placed thereon during high power-output cutting of the chainsaw 1010.

Each of the materials of each of the components (e.g., the guide bar 1200, the motor 1304, the housing 1100) of the chainsaw 1010 are selected to minimize weight of the chainsaw 1010 while providing adequate capacity to operate the chainsaw 1010 at a high power-output. For example, the guide bar 1200 may be a lightweight and high strength steel alloy, stainless-steel alloy, aluminum alloy, or the like. Accordingly, the guide bar 1200 may resist corrosion, hold strong edges for engaging the chain 1204, while retaining enough elasticity to bend under high stress without breaking. The motor 1304 may also be a lightweight and high power-output motor such as, without limitation, a brushless direct current motor. In other words, the motor 1304 may have a high power-to-weight (i.e., PWR, i.e., specific power) ratio. Another example of lightweight component selection in the chainsaw 1010 is the housing 1100 itself. The housing 1100 may be composed of a durable and light-weight plastic material. The housing 1100 may optionally be formed of injection molded plastic comprising of a base material and an additive. The base material and the additive of the housing 1100 each contributing to the structural rigidity and weight of the housing 1100. Total weight of the chainsaw 1010 less the battery pack 1400 (i.e., including the guide bar 1200, the power and drive assembly 1300, and the housing 1100) in the illustrated embodiment is approximately 4.74 pounds (2.15 kilograms). Other embodiments may have different total weights for the chainsaw 1010.

The above-described features of the chainsaw 1010 provide a high power-output and light weight chainsaw 1010 with a compact guide bar 1200 and a compact housing 1100. As previously mentioned, a maximum instantaneous mechanical output power of the chainsaw 1010 while cutting 3.5-inch by 3.5-inch (8.9-centimeter by 8.9-centimeter) pressure-treated lumber is approximately 1200 Watts. Other improved higher output chainsaws are envisioned upon realizing increases in efficiency of components of the chainsaw 1010.

As previously mentioned, the weight of the chainsaw 1010 less (i.e., without) the battery pack 1400 is approximately 4.74 pounds, and the maximum output power of the chainsaw 1010 is approximately 1200 Watts. Accordingly, the chainsaw 1010 is a high power-output and lightweight chainsaw having a power-to-weight ratio of output mechanical power to total weight above 150 Watts per pound (330 Watts per kilogram). More specifically, the chainsaw 1010 has a power-to-weight ratio of output mechanical power to total weight above 250 Watts per pound (550 Watts per kilogram). The illustrated chainsaw 1010 has a power-to-weight ratio of output mechanical power to total weight of approximately 253 Watts per pound (557 Watts per kilogram).

As previously mentioned, the guide bar length L1 of the illustrated guide bar 1200 is approximately 7.5 inches (19 centimeters), and the maximum output power of the chainsaw 1010 is approximately 1200 Watts. Accordingly, the chainsaw 1010 is a high power-output and compact guide bar 1200 chainsaw 1010 having a power-to-length ratio of output mechanical power to guide bar length L1 greater than 100 Watts per inch (39 Watts per centimeter). More specifically, the chainsaw 1010 has a power-to-length ratio of output mechanical power to guide bar length L1 greater than 140 Watts per inch (55 Watts per centimeter). The illustrated chainsaw 1010 has power-to-length ratio of output mechanical power to guide bar length L1 approximately 160 Watts per inch (63 Watts per centimeter).

As previously mentioned, the maximum housing length L2 of the illustrated housing 1100 is approximately 12 inches, and the maximum output power of the chainsaw 1010 is approximately 1200 Watts. Accordingly, the chainsaw 1010 is a high power-output and compact housing 1100 chainsaw 1010 having a power-to-length ratio of output mechanical power to maximum housing length L2 greater than 50 Watts per inch (20 Watts per centimeter). More specifically, the chainsaw 1010 has a power-to-length ratio of output mechanical power to maximum housing length L2 greater than 75 Watts per inch (30 Watts per centimeter). The illustrated chainsaw 1010 has power-to-length ratio of output mechanical power to maximum housing length L2 approximately 100 Watts per inch (40 Watts per centimeter).

Various features of the disclosure are set forth in the following claims.

What is claimed is:

1. A chainsaw comprising:
a housing including a handle housing portion, a motor housing portion, and a drive housing portion, the handle housing portion having a cavity extending along a longitudinal axis that defines a first axis of the chainsaw and at least one grip surface configured to be grasped during operation of the chainsaw;
a knob positioned on a lateral side of the drive housing portion, the knob including a round portion adjacent the drive housing portion and a graspable portion coupled to the round portion;
a motor supported within the motor housing portion, the motor including an output shaft having a longitudinal axis that defines a second axis of the chainsaw,
a driven gear coupled to the output shaft such that the driven gear rotates in response to rotation of the output shaft;
a sprocket coupled to the driven gear such that rotation of the driven gear rotates the sprocket;
a guide bar extending from the drive housing portion and having a longitudinal axis that defines a third axis of the chainsaw, the guide bar including an internal portion disposed within the drive housing portion and a projecting portion extending beyond a forward-most edge of the drive housing portion by a distance between 4 inches and 8 inches,
a chain supported on the guide bar and engaged with the sprocket such that rotation of the sprocket moves the chain along the guide bar, the chain including a plurality of cutting elements having a semi-chisel configuration;
a battery configured to provide power to the motor, the battery being received in the cavity along the first axis such that the battery substantially fills the cavity; and
a trigger switch positioned on the handle housing portion for controlling operation of the chainsaw,
wherein the first axis and the second axis define an included angle less than 75 degrees,
wherein the second axis and the third axis define a second included angle between 110 degrees and 130 degrees, and
wherein the first axis and the third axis define an external angle between 150 degrees and 170 degrees.

2. The chainsaw of claim 1, wherein the battery includes three battery cells with a lithium-ion chemistry.

3. The chainsaw of claim 2, wherein the motor is a brushed DC motor.

4. The chainsaw of claim 3, wherein the trigger switch includes an on/off switch.

5. The chainsaw of claim 1, wherein the chainsaw is configured to be operated with one hand.

6. The chainsaw of claim 5, wherein the first axis, the second axis, and the third axis are oblique with respect to each of the other axes.

7. The chainsaw of claim 1, wherein the driven gear is a bevel gear including teeth facing the lateral side of the drive housing portion.

8. The chainsaw of claim 1, wherein the motor is positioned above the guide bar.

9. The chainsaw of claim 1, further comprising a lubrication system configured to supply lubricant to the chain during operation of the chainsaw.

10. The chainsaw of claim 9, wherein the lubrication system includes a lubricant reservoir coupled to an exterior of the housing and a conduit extending from the lubricant reservoir into the drive housing portion.

11. A chainsaw comprising:
a housing including a handle housing portion, a motor housing portion, and a drive housing portion, the handle housing portion having a cavity extending along a longitudinal axis that defines a first axis of the chainsaw and at least one grip surface configured to be grasped during operation of the chainsaw;
a workpiece engaging member positioned on the drive housing portion and configured to engage a workpiece to provide a pivot point during a cutting operation of the chainsaw;
a brushed DC motor supported within the motor housing portion, the motor including an output shaft having a longitudinal axis that defines a second axis of the chainsaw,
a driven gear coupled to the output shaft such that the driven gear rotates in response to rotation of the output shaft;
a sprocket coupled to the driven gear such that rotation of the driven gear rotates the sprocket;
a guide bar extending from the drive housing portion and having a longitudinal axis that defines a third axis of the chainsaw, the guide bar including an internal portion disposed within the drive housing portion and a projecting portion extending beyond a forward-most edge of the drive housing portion by a distance between 4 inches and 8 inches,
a chain supported on the guide bar and engaged with the sprocket such that rotation of the sprocket moves the chain along the guide bar, the chain including a plurality of cutting elements having a semi-chisel configuration;
a battery configured to provide power to the motor, the battery being received in the cavity along the first axis such that the battery substantially fills the cavity; and
a trigger switch positioned on the handle housing portion for controlling operation of the chainsaw, the trigger switch including an on/off switch,
wherein the first axis and the second axis define an included angle less than 75 degrees, and
wherein the first axis, the second axis, and the third axis are oblique with respect to each of the other axes.

12. The chainsaw of claim 11, wherein the chainsaw is configured to be operated with one hand.

13. The chainsaw of claim 12, wherein the driven gear is a bevel gear.

14. The chainsaw of claim 13, wherein the motor is positioned above the guide bar.

15. The chainsaw of claim 14, further comprising a lubrication system configured to supply lubricant to the chain during operation of the chainsaw.

16. The chainsaw of claim 15, wherein the lubrication system includes a lubricant reservoir coupled to an exterior of the housing and a conduit extending from the lubricant reservoir into the drive housing portion.

17. A chainsaw configured to be powered by a battery pack, the chainsaw comprising:
a housing including a battery interface for receiving the battery pack;
a guide bar for guiding a cutting chain, the guide bar removably coupled to the housing;
a power and drive assembly including
a motor disposed within the housing, the motor configured to be powered by the battery pack, and
a gear train driven by the motor and configured to drive the cutting chain;
wherein the housing, the guide bar, and the power and drive assembly each contribute to a total weight of the chainsaw; and
wherein a power output by the power and drive assembly compared to the total weight defines a power-to-weight ratio of above 150 Watts per Pound.
